(19) United States
(12) Patent Application Publication
(10) Pub. No.: US 2014/0324272 A1
(43) Pub. Date: Oct. 30, 2014

(54) Operating system for and method of operating an automatic guidance system of an agricultural vehicle

(71) Applicant: CLAAS AGROSYSTEMS KGAA MBH & CO KG, Guetersloh (DE)

(72) Inventors: Tommy Ertbolle Madsen, Virum (DK); Soeren Steen, Kokkedal (DK); Kim Amhild, Copenhagen N (DK)

(73) Assignee: CLAAS AGROSYSTEMS KGAA MBH & CO KG, Guetersloh (DE)

(21) Appl. No.: 14/260,350

(22) Filed: Apr. 24, 2014

(30) Foreign Application Priority Data
Apr. 29, 2013 (EP) 13165699.3

(51) Int. Cl. A01B 69/04

(52) U.S. Cl. CPC A01B 69/008
USPC 701/28

(57) ABSTRACT

An operating system for operating an automatic guidance system of an agricultural vehicle includes a three-dimensional imaging device for capturing a real object and for deriving a three-dimensional data set for the real object and, a touch-sensitive display unit for displaying an object and for receiving a touch input. The operating system is configured for generating three-dimensional data set based command signals corresponding to the interaction with the displayed object for operating the automatic guidance system. The operating system allows for an easy and efficient way to operate the automatic guidance system, reducing the stress and workload for the operator.

### CROSS-REFERENCE TO A RELATED APPLICATION

The invention described and claimed hereinbelow is also described in European Priority Document EP 13 165699.3, filed on Apr. 29, 2013. The European Priority Document, the subject matter of which is incorporated herein by reference, provides the basis for a claim of priority of invention under 35 U.S.C. 119(a)-(d).

### BACKGROUND OF THE INVENTION

The present invention relates to an operating system for operating an automatic guidance system of an agricultural vehicle, an agricultural vehicle comprising the operating system of an agricultural vehicle and a method of operating an automatic guidance system of an agricultural vehicle.

An agricultural vehicle, such as a tractor, a combine or a forage harvester, is often used in a way that while driving the agricultural vehicle an operator needs to control several tasks, for example, filling grain in a tank, controlling the settings of a sprayer or a plow, etc.

In order to relieve the operator, automatic steering devices have been developed, for example, based on a camera system. EP 2 094 073 A1 discloses a method by which image data from the terrain lying in front of a vehicle in the direction of travel are detected, and from which data steering commands to influence the direction and/or the speed of travel are generated. Prominent objects are selected by use of the image data. The distance between the agricultural vehicle and the prominent objects is determined. Steering commands are generated from the image data which correspond to the objects and from the changes of distance between the vehicle and the objects.

This device has the drawback, however, that the operator needs to monitor the device closely, because due to a miss-interpretation of the image data the device may not work properly, in which case the operator needs to take over the steering manually, thus increasing the workload for the operator.

### SUMMARY OF THE INVENTION

The present invention overcomes the shortcomings of known arts, such as those mentioned above.

To that end, the provides an operating system for a automatic guidance system of an agricultural vehicle, which improves the operating of the automatic guidance system by reducing the workload of the operator and a method for operating an automatic guidance system of an agricultural vehicle, which improves the operation of the automatic guidance system.

The operating system for operating an automatic guidance system of an agricultural vehicle comprises at least one three-dimensional imaging device for capturing a real object and for deriving a three-dimensional data set for the real object, and a touch-sensitive display unit for displaying an object and for receiving a touch input. The operating system generates three-dimensional data set based command signals corresponding to the interaction with the displayed object for operating the automatic guidance system.

An agricultural vehicle may be a combine harvester, a forage harvester, a transport vehicle, a tractor and/or a powered and/or steerable trailer. The operating system for operating an automatic guidance system is located on an agricultural vehicle with a transfer device or on another agricultural vehicle, for example, a tractor pulling a trailer or a steerable trailer. The transfer device can be an auger of a combine harvester or a spout of a forage harvester. The automatic guidance system is a three-dimensional imaging device based, automatic steering system or autopilot. The automatic guidance system comprises a navigation system and/or a route planning system, for example, for determining an optimal route to pick up bales on a field. The agricultural vehicle comprises a control unit for controlling the agricultural vehicle, in particular, actuators moving a steering system, a throttle and/or brakes of the agricultural vehicle, wherein the control unit is configured to generate control signals to move the agricultural vehicle, for example, by controlling the steering system, the throttle and/or the brakes, in a desired position.

The operating system comprises at least one three-dimensional imaging dew vice for capturing real objects in the real world in order to generate a displayable two-dimensional image to interact with. On capturing the real object, the three-dimensional imaging device, in particular, a processing unit of the three-dimensional imaging device, derives a three-dimensional data set and/or a three-dimensional range image for the captured real object, for example, the surroundings of the agricultural vehicle. A distance for each pixel of the three-dimensional imaging device is calculated. Distance information relates to an absolute distance and/or a relative distance. The three-dimensional imaging device captures real objects in real time. A real object also may be an object located in the surroundings of the agricultural vehicle. A real object may be another agricultural vehicle, tracks on the ground and/or an obstacle. An obstacle may be a tree, a fence or a geological area, for example a pond, a trench, soft and/or wet soil, a bank or an acclivity.

The derived three-dimensional data set comprises distance information and/or three-dimensional coordinates of the real object. The distance information is relative to the operating system and/or the agricultural vehicle and/or absolute, for example, as three-dimensional coordinates. The absolute distance information is generated together with a navigation system, in particular, with a satellite based navigation system, for example the global positioning system (GPS). The navigation system provides three-dimensional coordinates, in particular, for the three-dimensional imaging system and/or the agricultural vehicle, based on which the three-dimensional coordinates of the real object is calculated by determining the position, for example, distance and bearing, of the real object relative to the three-dimensional imaging device and/or the agricultural vehicle.

The captured real object is visualized for displaying on a display unit, for example, in form of a range image. The visualization of the captured object may be in form of a live image and/or live video or in form of an artificial video and/or artificial image suitable for visualising the captured distance information to an operator of the operating system. For each visualised, and in particular displayed, pixel on the display unit a corresponding distance information is calculated. A pixel of the three-dimensional imaging device is the smallest capturable point of the image resolution of the imaging device, wherein a pixel of the display is the smallest addressable element of the display unit. The resolution of the three-dimensional imaging device is higher than the resolution of the display unit, wherein the three-dimensional data set corresponds to the higher resolution of the three-dimensional imaging device.

The display unit is a multifunctional display unit configured to receive touch input, in particular, multi touch input, for example, up to and including a multi touch input with five fingers. The multifunctional display comprises several subareas, for example, in form of a split screen, for independently displaying information and independently receiving touch input. The multifunctional display comprises additional input elements like buttons and/or wheels. The display unit receives data from the three-dimensional imaging device for displaying, for example, a captured and visualised real object and/or a virtual element. Objects, for example, in form of a live video of a real object or in form of a virtual element, displayed on the display unit are displayed objects, wherein a three-dimensional data set corresponds to each, in particular, captured and/or visualised, displayed objects. Displayed objects are enlarged on the display unit, for example by executing an according input gesture.

The display unit displays the captured and visualized objects and receives and/or detects feedback in form of touch input, in particular, corresponding to a displayed object. The touch input is received in form of detected two-dimensional coordinates relating to the executed touch input, in particular, to the executed input gesture. The touch input is in form of several different input gestures, wherein the response of the operating system to the different input gestures is predefined. The displayed object is interacted with by touch input. The interaction with the displayed object is by manipulating the displayed object by hand, in particular, with at least one finger by touch input. The displayed object is selected, moved and/or altered in shape and/or size. An interaction is displayed on the display unit in real time, thus allowing for an interactive manipulation of the displayed object.

The received touch input, for example, a selection and/or a manipulation of the displayed object, is transmitted to the imaging device, for example, in form of the two-dimensional coordinates. The imaging device, in particular, the processing unit of the three-dimensional imaging device, allocates the received feedback, e.g., two-dimensional coordinates of the touch input, to the displayed object displayed at those coordinates. The three-dimensional imaging device evaluates the received feedback and correlates the feedback to the corresponding displayed object and the related three-dimensional data set.

The three-dimensional imaging device generates the three-dimensional data set based command signals corresponding to the received two-dimensional touch input. The commands signals are received by the control unit of the automatic guidance system as input signals for operating the automatic guidance system accordingly, for example, by operating the steering system of the agricultural vehicle accordingly. The command signals comprise position information of real objects, which may be necessary as input for the control unit in order to correctly control, for example, steer, accelerate and/or decelerate, the agricultural vehicle. The displayed object is interactively manipulable, wherein a two-dimensional manipulation of the displayed object corresponds to the generating of three-dimensional control commands. The control commands may, for example, be transmitted to the control unit of the transfer device in order to control the agricultural vehicle as desired, for example, in order to keep the vehicle in line with a swath or tracks.

The generating of three-dimensional data set based command signals corresponding to an interaction with the displayed object for operating the transfer device has the advantage, which the operator may manually interact with visual information provided by the three-dimensional imaging device. The visual information enables the operator to supervise the automatic guidance system and the manipulation of the displayed objects allows for a direct interaction, for example, realigning a displayed object indicating a track to follow, if an adjustment or other input is necessary. Thus, the operating system allows for an easy and efficient way to operate the automatic guidance system, reducing the stress and workload for the operator.

In an embodiment, the operating system is configured for generating command signals in form of control signals for directly controlling the agricultural vehicle. The three-dimensional imaging device is directly linked to actuators moving the steering system, in order to control the agricultural vehicle directly. The command signals generated by the imaging device, in particular, based on received touch input feedback, are control signals, which are directly controlling the actuators of the steering system, the throttle and/or the brakes of the agricultural vehicle. For example, a displayed object indicative of the tracks that the agricultural vehicle is to follow is selected and moved or altered by touch input. A movement and/or alteration of the displayed object by touch input leads to a directly linked movement of the steering system of the agricultural vehicle. This has the advantage, that the agricultural vehicle is controlled directly by the three-dimensional imaging device, which allows for a faster response of the steering system, for example, to touch input by the operator on the display unit. In addition, the direct interaction with the displayed object for operating the operating system improves the ease of handling of the system further.

Preferably, the operating system is configured for recognizing a captured real object. The operating system comprises a memory unit for storing reference data corresponding to real objects. The captured real object, in particular, the derived three-dimensional data set corresponding to the real object, is compared to predefined reference data in order to enable a recognition of a real object, for example, if it is a bale and/or if it is a round or square bale. If a captured real object is recognised, corresponding object data, for example, the dimensions of the real object like length, height and/or width, are allocated to the real object and/or displayed object and provided for the automatic guidance system. The object data comprises information about the size of a pond or the length of a row of trees, for example. The object data are pre-stored on the memory unit. This has the advantage, which precise data about the real object is efficiently made available, thus increasing the precision of the automatic guidance system without increasing the workload of the operator.

In an embodiment, the operating system is configured for allocating and/or changing data corresponding to a displayed object. The captured real object, in particular, the derived three-dimensional data set corresponding to the real object, is compared to predefined reference data in order to enable recognition of a real object, for example, if it is a round bale. In case a captured real object, that is shown as a displayed object on the display unit, has not been recognized, the operator allocates object data, for example, retrieved from the memory unit, to the displayed object corresponding to the real object. For example, the dimension and location of a known and stored pond can be allocated to the displayed object, i.e., pond, in order to enable the automatic guidance system, in particular, the navigation system of the automatic guidance system, to guide the agricultural vehicle safely around this obstacle. This has the advantage, that the operator can enable the automatic guidance system to safely guide the agricultural vehicle with a minimum of interaction with the operating system.

A displayed object is generated and displayed for a real object whose position, for example in form of three-dimensional coordinates, has been transmitted to the operating system.

The position of the real object is transmitted together with an identifier for identifying, for example, the type of object. The position, and in particular identifier of the real object is transmitted to the operating system by another agricultural vehicle.

The object data corresponding to the real object whose position, and in particular identifier has been transmitted to the operating system is retrieved from the memory unit in order to reduce the data that needs to be transmitted. Such a real object may for example be another agricultural vehicle, tracks on the ground and/or an obstacle. An obstacle may be a tree, a fence or a geological area, for example, a pond, a trench, soft and/or wet soil, a bank or an acclivity. The displayed object is corrected by the operator (where necessary) by interacting with the displayed object on the touch screen. To any displayed object, for example, a position on the displayed surroundings of the agricultural vehicle, data is allocated. For example, the operator may select, by input gesture on the display unit, a point of interest, for example, a point of return when interrupting his work.

In this case the two-dimensional input is transferred into three-dimensional position information which is used by the automatic guidance system to guide the agricultural vehicle to the selected point of interest. Also, the operator selects a point-of-interest in the two-dimensional display, which is the transferred into a three-dimensional position information or coordinate, ordering the automatic guidance system, for example, by input gesture, to automatically guide the agricultural vehicle to the desired position. The object data is changed, for example, in case the real object has been wrongly recognised or alterations to the object data, for example, the dimensions of an obstacle, are necessary. The allocation and/or changing of to data corresponding to a displayed object is executed by touch input, in particular, by an input gesture, on the display unit, in particular, by altering the displayed object. This has the advantage that the operator may easily and more efficiently operate the automatic guidance system, reducing the workload for the operator.

In an embodiment, the operating system is configured for generating a visual and/or audible feedback, in particular, to a touch input. A touch input, for example, for selecting and/or manipulating a displayed object, may cause an audible and/or visual feedback in order to indicate to the operator the execution of the desired action. The audible and/or visible feedback is given by a visual indication on the display unit, an indicator light and/or an audible signal like a tone or a message. This has the advantage, that the operator gets a distinct feedback to his input.

Preferably, the operating system is further configured for generating at least one virtual element corresponding to a displayed object. The virtual element is generated by the three-dimensional imaging device and displayed on the display unit, for example, laying over a displayed real object. The virtual element is interactively manipulable by touch input. A displayed object may be a displayed real object, for example, as a live image and/or video and/or a virtual element. A virtual element is generated according to a recognised and/or displayed real object, for example, in form of an artificial image of the real object, a symbol, or graphical elements. The object data corresponding to the displayed real object may, for example, comprise information about the dimensions of the real object, for example, a pond or a round bale, and/or information about security distances indicating how close to an obstacle the agricultural vehicle may be driven. A virtual element representing security distances in headland prediction or around an obstacle or borders of a field may be shown as displayed objects, virtual elements, laid over a live image of the real object, i.e., the field.

The object data may be changed, for example, in case the real object has been wrongly recognised or alterations to the object data are necessary, by interacting with the virtual element. For example, security distances of the headland prediction or around an obstacle are altered by selecting and moving them by touch input, widening or narrowing the safety distance, thus generating command signals for the control unit, allowing the automatic guidance system to guide the agricultural vehicle accordingly. The advantage of a virtual element is an increase in information that may be shown to the operator without increasing the workload. Additionally, further interactions can be incorporated into the operating system, enhancing the input options for the operator.

In an embodiment, the three-dimensional imaging device comprises at least one electro-optical range imaging device in form of a stereo camera, a light detecting and ranging device and/or a time-of-flight camera. The electro-optical range imaging device is an active and/or passive range imaging device for generating an interactive two-dimensional image of a captured three-dimensional real world and/or a three-dimensional real object showing the distance to individual points in a scene of the real world from the electro-optical range imaging device.

The light detection and ranging device, called LIDAR or LADAR, which is short for Laser Imaging Detection and Ranging, is an active optical remote sensing technology that measures a distance to an object, like the ground or a real object, by illuminating the target with laser light and analyzing the backscattered light. The time-of-flight camera, as an active range imaging device resolves distance based on the known speed of light, measuring the time-of-flight of a light signal between the camera and a real object for each point of the image.

The three-dimensional imaging device can be radar or an ultra-sonic based range imaging device. Different kinds of three-dimensional imaging devices may be combined. A resulting three-dimensional data set may be visualized as a corresponding range image, wherein the range image comprises pixel values each corresponding to a distance. The range image is visualized from the three-dimensional data set by the three-dimensional imaging device in order to provide an image displayable on the display unit for the operator in form of a live image and/or video of the real world and/or object. The stereo camera, as a passive range imaging device, derives the three-dimensional data set and the corresponding pixel values for a real object directly from the captured image. The range image is assembled from separate three-dimensional data sets and/or range images in form of a panoramic picture. The individual range images originate from one or more, even different, three-dimensional imaging devices. This has the advantage, that the field of view can be enlarged.

The invention further relates to an agricultural vehicle comprising at least one operating system as described above. The inventive operating system allows for an easy and efficient way to operate the automatic guidance system, reducing the stress and workload for the operator.

The invention also provides a method of interactively operating, by an operating system as described above, an automatic guidance system of an agricultural vehicle. The method includes

deriving a three-dimensional data set for a real object captured by a three-dimensional imaging device,

displaying an object on the touch-sensitive display unit,

receiving feedback from the display unit from touch input interaction with the displayed object, and

generating three-dimensional data set based command signals corresponding to the interaction with the displayed object for operating the automatic guidance system.

A three-dimensional imaging device captures an image of a real object in the real world for deriving a three-dimensional data set for the captured real object. The three-dimensional data set comprises information such as position information about the distance of the real object to the imaging device and/or the agricultural vehicle. The automatic guidance system is a three-dimensional imaging device based, automatic steering system or autopilot. The automatic guidance system comprises a navigation system and/or a route planning system for determining a route to pick up detected bales on afield. The automatic guidance system comprises a control unit for controlling the agricultural vehicle, in particular, actuators moving a steering system, a throttle and/or brakes of the agricultural vehicle. The control unit is configured to generate control signals to move the agricultural vehicle, for example, by controlling the steering system, the throttle and/or the brakes, in a desired position. Each pixel of the captured image of the imaging device comprises distance information from the real object to the imaging device. The three-dimensional data set coordinates.

The three-dimensional coordinates are generated by support of a navigation system such as a satellite based navigation system, for example, the global positioning system (GPS). The navigation system provides three-dimensional coordinates, in particular, for the three-dimensional imaging system and/or the agricultural vehicle, based on which the three-dimensional coordinates of the real object are calculated by determining the position, e.g., distance and bearing, of the real object relative to the three-dimensional imaging device and/or the agricultural vehicle.

Visualizing the captured real object provides a displayable image of the image captured by the imaging device. The visualisation of the real object is in form of a live and/or an artificial image and/or video of the real object. This allows for a presentation of the three-dimensional information that is easily absorbed by an operator of the agricultural vehicle operating the automatic guidance system. For displaying the visualised captured real object, information is transmitted from the imaging device to a touch sensitive display unit. The visualised captured real object is displayed as a displayed object on the display unit, wherein several objects are displayed in one or more subareas of the display unit separately and/or together. The display unit is sensitive to multi touch input for each subarea and/or displayed object.

A displayed object is interacted with by touching the touch sensitive display unit in the area showing the displayed object. The interacting be in form of selecting the displayed object and/or by manipulating the displayed object, for example, its shape and/or dimensions. The touch input is registered as feedback by the display unit in two-dimensional coordinates. The two-dimensional coordinates of the feedback and the interaction with the displayed object are transmitted back to the three-dimensional imaging device. The three-dimensional imaging device correlates the two-dimensional coordinates to the three-dimensional data set corresponding to the displayed object, for example, to a three-dimensional coordinates of the real object corresponding to the displayed object.

Based on the interaction with the displayed object command signals for operating the automatic guidance system according to the interaction is generated, based on the three-dimensional data set. The command signals are transferred as input signals to a control unit controlling the transfer device. The generated command signals comprise three-dimensional data set based information corresponding to the touch input such as three-dimensional coordinates of a selected position or an intended movement of the agricultural vehicle to the selected position. The signals are then transmitted as input signals to the control unit, which controls automatic guidance system accordingly in order to execute the movement and/or operation of the agricultural vehicle intended by the interaction with the displayed object. For example, a real object like a round bale displayed on the display unit is marked and the three-dimensional coordinates of the bale stored or transferred to a route planning system.

Also, a displayed object in form of an obstacle is selected by touch input and a safety distance is chosen in order to enable the automatic guidance system to circumnavigate the obstacle safely, wherein the two-dimensional coordinates of the touch input are transmitted to the imaging device. The imaging device correlates these two-dimensional coordinates to three-dimensional coordinates based on the three-dimensional data set of the displayed object in form of an obstacle. This three-dimensional coordinate is then transmitted as input signals to a control unit controlling the transfer device, so that the control unit may guide the agricultural vehicle accordingly.

The generating of three-dimensional data set based command signals corresponding to an interaction with the displayed object for operating the automatic guidance system has the advantage, that the operator may manually interact with visual information provided by the three-dimensional imaging device for operating the automatic guidance system. The visual information enables the operator to efficiently supervise the route following and the automated avoidance of obstacles. Thus, the operating system allows for an easy and efficient way to operate the automatic guidance system, reducing the stress and workload for the operator.

In an embodiment, the method further comprises a step of generating command signals in form of control signals for directly controlling the agricultural vehicle. The three-dimensional imaging device is directly linked to actuators moving the steering system of the agricultural vehicle, in order to control the agricultural vehicle directly. The command signals generated by the imaging device based on received touch input feedback are control signals that directly control the actuators of the steering system, the throttle and/or the brakes of the agricultural vehicle. Thus, the interaction with the displayed object by touch input is directly transferred into control signals for directly controlling at least one actuator of the agricultural vehicle.

This has the advantage, that the agricultural vehicle id controlled directly by the three-dimensional imaging device, which allows for a faster response to touch input by the operator on the display unit. For example, a displayed object indicative of the tracks that the agricultural vehicle is to follow is selected and moved or altered by touch input. A movement and/or alteration of the displayed object by touch input may lead to a directly linked movement of the steering system of the agricultural vehicle. This has the advantage, that the agricultural vehicle may be controlled directly by the three-dimensional imaging device, which allows for a faster response of the steering system for example to touch input by the operator on the display unit.

In a preferred embodiment, the method comprises the step of recognizing a captured real object. A captured real object such as the derived three-dimensional data set corresponding to the real object is compared to predefined reference data in order to enable recognition of a real object. The reference data is pre-stored on a memory unit. When recognising a real object by comparing the derived three-dimensional data set with reference data, corresponding object data is allocated to the captured real object and provided for controlling the automatic guidance system. The object data is pre-stored on the memory unit. Object data may, for example, be the precise dimensions of the real object, like height, width, length. This has the advantage that precise data about the real object, like an obstacle with corresponding safety lines, is efficiently made available for operating the automatic guidance system thereby increasing the precision of the guidance of the agricultural vehicle without increasing the workload of the operator.

In an embodiment, the method comprises the step of storing and/or retrieving reference data for comparing a derived three-dimensional data set with reference data. Reference data is retrieved and used for comparing the derived three-dimensional data set from a captured real object with pre-stored data. In case a real object may not be recognised, in particular, if no reference data is available, the derived three-dimensional data set of the captured unrecognized real object is stored in the memory unit as reference data. This could be the case if a new obstacle is detected, like a pond. The stored reference data may be complemented with further, more precise information about the real object, like the dimensions of the obstacle and safety distances to be considered. This has the advantage that an unrecognized real object such as an obstacle only needs to be stored once in order to automatically recognize it afterwards thereby reducing the workload for the operator.

In an embodiment, the method further comprises the step of allocating and/or changing data corresponding to a displayed object. The data corresponding to a displayed object are three-dimensional data set, object data and/or reference data. In case a captured real object, that is shown as a displayed object, has not been recognized, object data is allocated to the displayed object by the operator. The allocated object data may be retrieved from the memory unit, for example, standard safety distances to be considered from known types of obstacles like tree lines. In case a captured real object that is shown as a displayed object has not been recognised correctly, the object data allocated to the displayed object may be changed by the operator, for example, by retrieving the correct object data from the memory unit and/or by altering the object data by touch input on the display unit.

A displayed object also may be generated and displayed for a real object whose position in form of three-dimensional coordinates has been transmitted to the operating system. The position of the real object is transmitted together with an identifier for identifying the type of object. The position, and in particular identifier, of the real object is transmitted to the operating system by another agricultural vehicle. The object data corresponding to the real object whose position, and in particular identifier, has been transmitted to the operating system is retrieved from the memory unit in order to reduce the data that needs to be transmitted. Such a real object may be another agricultural vehicle, tracks on the ground and/or an obstacle. An obstacle may be a tree, a fence or a geological area, a pond, a trench, soft and/or wet soil, a bank or an acclivity. The displayed object, for example, the displayed size of an obstacle, may be corrected by the operator by interacting with the displayed object on the touch screen. Another agricultural vehicle may displayed, for example, as a collision warning to the operator. This has the advantage that the guidance of the agricultural vehicle is more efficient due to more precise data and more information visualized for the operator.

Preferably, the method further comprises the step of generating a visual and/or audible feedback to a touch input. Interacting with the displayed object such as touch input is supported by audio and/or visual feedback in order to indicate the execution of the desired action. The audible and/or visible feedback is given by a visual indication on the display unit, an indicator light and/or an audible signal like a tone or a message. This has the advantage, that the operator gets a distinct feedback to his input.

In an embodiment, the method further comprises the step of generating at least one virtual element corresponding to a displayed object. The virtual element is generated by the three-dimensional imaging device and displayed on the display unit. The virtual element is laid over the visualised real object. The virtual element is interactively manipulable by touch input. A displayed object may be a real object, for example, displayed as a live image and/or video, and/or a virtual element. The virtual element is generated according to a displayed and/or recognised real object, for example, in form of an artificial image of the real object, a symbol, or graphical elements.

For generating a virtual element, object data corresponding to the displayed and recognized real object are incorporated, for example, by incorporating object information into the virtual element, like an indication of the security distances indicating how close to an obstacle the agricultural vehicle may be guided, i.e., driven. A virtual element representing security distances of an obstacle is shown as a displayed object, in form of virtual elements, laid over a live image of the obstacle. The interaction with the displayed object, for example, in form of a virtual element, is transferred into three-dimensional data set based command signals by transmitting the altered security distances in form of relative, three-dimensional coordinates to the control unit. This enables the control unit to move and operate the agricultural vehicle according to the new security distances. The advantage of a virtual element is an increase in information that may be shown to the operator without increasing the workload. Additionally further interactions can be incorporated into the operating system, enhancing the input options for the operator.

In an embodiment, the method further comprises the step of selecting a displayed object for tracking the corresponding real object. A displayed object is selected by touch input, wherein the generated three-dimensional data set and three-dimensional coordinates is used for closing and/or avoiding the chosen real object and/or for tracking the selected real object, constantly updating the three-dimensional coordinates of the real object. This has the advantage, that an obstacle, for example, a person, is easily selected and avoided by the automatic guidance system.

In an embodiment, the method comprises the step of transferring three-dimensional data sets to a further system. The three-dimensional data sets of the automatic guidance system are transferred to another system, for example, navigation and/or route planning system of the agricultural vehicle or an external system. Transferring three-dimensional data sets comprising information about the three-dimensional coordinates of round bales that have been detected by the three-dimensional imaging system enables a route planning system to derive a route for picking up the round bales. The agricultural vehicle is then automatically guided along this route by an automatic guidance system according to the invention.

### BRIEF DESCRIPTION OF THE DRAWINGS

Further features and advantages of the invention will become apparent from the description of embodiments that follows, with reference to the attached figures, wherein:

FIG. 1 presents a schematic view of agricultural vehicles with an operating system according to the invention;

FIG. 2 presents a schematic view of an operating system according to the invention;

FIG. 3: illustrates interacting with a displayed obstacle; and

FIG. 4: illustrates interacting with a virtual element.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

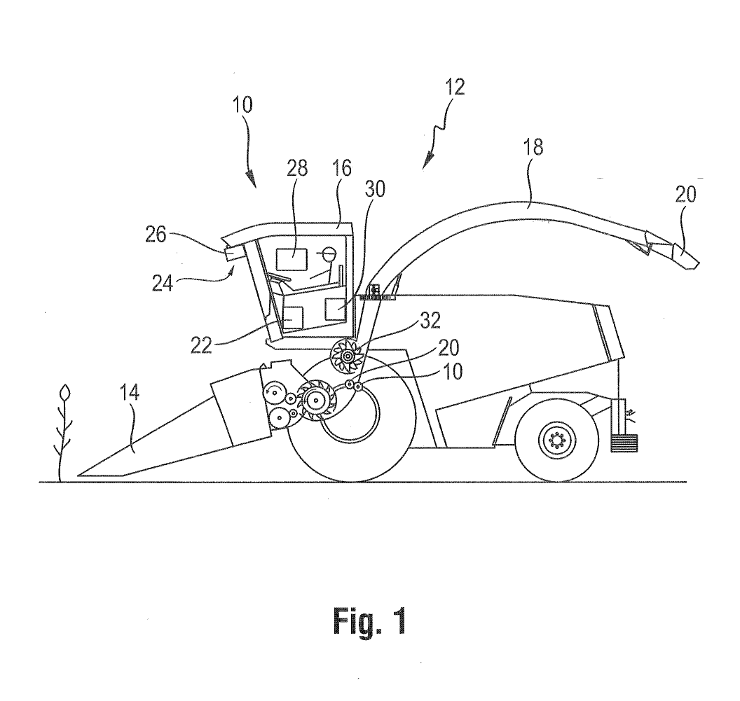

FIG. 1 provides a schematic view of an operating system 10 mounted on an agricultural vehicle 12 in form of a forage harvester comprising a header 14, a cabin 16 and a controllable transfer device 18 with a controllable flap 20 at its free end. During operation, the harvested goods are processed by the harvester 12 and ejected through the transfer device 18. The agricultural vehicle 12 comprises an automatic guidance system 22 for keeping the agricultural vehicle automatically on track during harvesting. A three-dimensional imaging device 24 with an electro-optical range imaging device in form of a stereo camera 26 for capturing real objects, like harvest, is attached to the front of the agricultural vehicle 12. The three-dimensional imaging device 24 (as shown) is overlooking and capturing at least part of the surroundings of the agricultural vehicle 12. The three-dimensional imaging device 24 is connected to a touch sensitive display unit 28 for displaying a visualised image of the real object captured by the stereo camera 26. The automatic guidance system 22 is connected to the operating system 10 and a control unit 30 of the agricultural vehicle 12, configured to receive command signals.

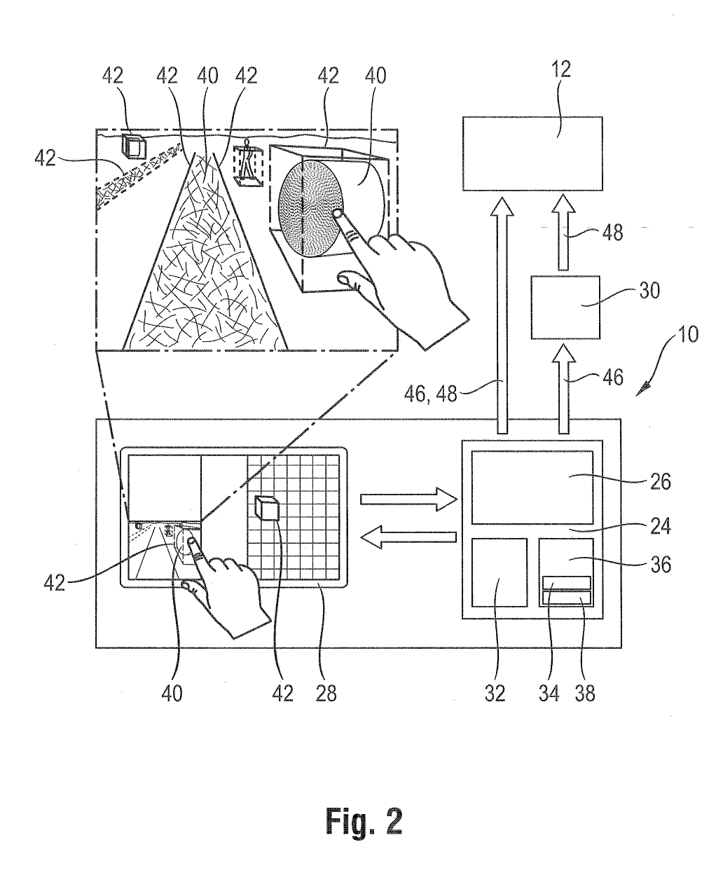

FIG. 2 presents a schematic view of the operating system 10. The stereo camera 26 of the three-dimensional imaging device 24 captures a real object in form of a swath and a round bale in front of the agricultural vehicle 12. The three-dimensional imaging device 24 comprises a processing unit 32 for deriving a three-dimensional data set for the captured real object in form of the swath and the round bale. The captured real object is visualised for display on the touch sensitive display unit 28. Visualizing means process the captured information from the three-dimensional imaging device 24 into a displayable and visually recognizable form for an operator of the operating system 10.

The three-dimensional data set is compared with reference data 34 stored in a memory unit 36 of the three-dimensional imaging device 24. If the real object is recognised, based on the comparing of the generated three-dimensional data set with the stored reference data 34, object data 38 corresponding to the recognized real object is allocated to the object. The object data 38 also is stored in the memory unit 36. The object data 38 comprises additional information about the real object, for example, the precise dimensions of the round bale, which may be used for calculating the needed transport capacity to pick all detected bales up. The visualised information of the captured real object is transmitted to the display unit 28 and shown as a displayed object 40 in at least part of the touch sensitive display unit 28 (the displayed live image of the real object is shown enlarged in FIG. 2). The displayed object 40 is a live image and/or video, a synthetic image and/or a virtual element 42. The virtual element 42 comprises and visualizes additional information about a displayed object 40, in this case the boundary lines of the detected swath and security distances around the round bale. In this case the virtual element 42 corresponding to the round bale is an obstacle warning. The virtual element 42 of the round bale is shown as a cubic frame indicating the round bale. The virtual elements 42 corresponding to the swath are lines indicating the boundaries of the swath. A boundary of a further swath, which is detected but momentarily not followed by the automatic guidance system 22, is indicated by a virtual element 42 in form of a dashed line.

The displayed objects 40 are interactively manipulable by touch input, in particular, by predefined input gestures. The virtual element 42 corresponding to the round bale is selected by touch input, for example, with the index finger and may be enlarged, as safety distance or otherwise interacted with. This touch input is transmitted back to the three-dimensional imaging device 24 as feedback comprising the two-dimensional coordinates of the touch input. If the operator were to increase the size of the selected displayed object 40 in form of the obstacle warning corresponding to the round bale, the three-dimensional imaging device 24 generates three-dimensional data set based command signals 46 according to the interaction with the displayed object 40 for operating the automatic guidance system 22 accordingly and automatically guide the vehicle around the obstacle.

The control commands 46 are sent to the control unit 28 of the agricultural vehicle 12 in order to control and guide the agricultural vehicle 12 accordingly, for example, steering the agricultural vehicle according to the desired input. Thus, control commands 46 may be commands for operating the agricultural vehicle 12 in a certain way, in particular chronologically independent from the touch input. A special type of command signals 46 are control signals 48, generated to directly control at least one actuator, for example, of the steering system of the agricultural vehicle, for controlling, i.e., steering, the agricultural vehicle 12 directly.

The control signals 48 are generated by the control unit 30 and/or the three-dimensional imaging device 24, such as the processing unit 32 of the three-dimensional imaging device 24. In the case of the obstacle in form of a round bale, the dragging of the corresponding virtual element 42 could, according to the input gesture, result in the agricultural vehicle 12 being steered in real time to follow the interaction with the displayed object 40, which may be a location to drive to, in form of a touch input on the display unit 28.

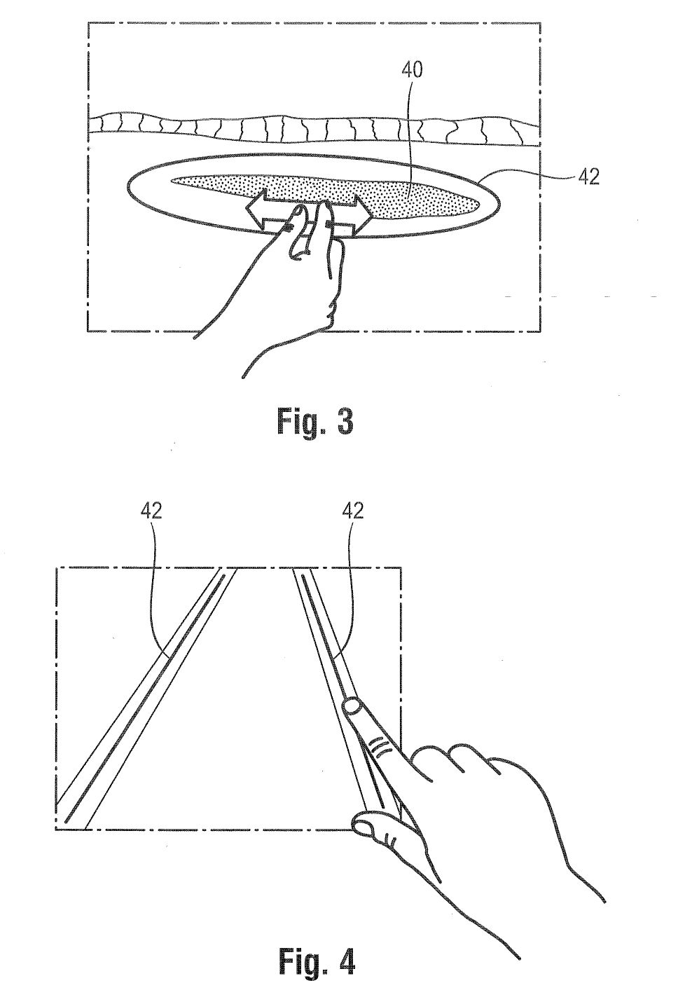

The selecting of a displayed object 40 in form of a pond is shown in FIG. 3. The pond is an obstacle selected by interacting with the displayed object 40, representing the pond, for example by increasing the allocated virtual element 42 indicative of a safety distance to be considered around the pond. The touch input is transmitted to the three-dimensional imaging device 24 which generates control commands 46 for positioning the agricultural vehicle 12 accordingly in order to navigate safely around the pond.

The selecting and altering of virtual elements 42 representing a track on which the agricultural vehicle is to be steered is shown in FIG. 4. According to the recognised track lines are shown as virtual elements 42, indicating the tracks which the operating system 10 has detected. The lines are repositioned by selecting and dragging the virtual elements 42 into a more precise position. Thus, the precision of the automatic guidance system is increased efficiently by the operator of the agricultural vehicle.

### LIST OF REFERENCE SIGNS

10 Operating system
12 agricultural vehicle
14 header
16 cabin
18 transfer device
20 flap
22 automatic guidance system
24 three-dimensional imaging device
26 stereo camera
28 display unit
30 control unit
32 processing unit
34 reference data
36 memory unit
38 object data
40 displayed object
42 virtual element
46 command signal
48 control signal

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An operating system for operating an automatic guidance system of an agricultural vehicle, comprising:
at least one three-dimensional imaging device for capturing a real object and for deriving a three-dimensional data set for the real object; and
a touch-sensitive display unit for displaying an object and for receiving a touch input,
wherein the operating system is configured to generate three-dimensional data set based command signals corresponding to the interaction with the displayed object for operating the automatic guidance system.

2. The operating system according to claim 1, further configured to generate the command signals in form of control signals for directly controlling the agricultural vehicle.

3. The operating system according to claim 1, further configured for recognising a captured real object.

4. The operating system according to claim 1, further configured for allocating and/or changing data corresponding to the displayed object.

5. The operating system according to claim 1, further configured for generating a visual feedback, an audible feedback or both in response to a touch input.

6. The operating system according claim 1, configured for generating at least one virtual element corresponding to the displayed object.

7. The operating system according to claim 1, wherein the three-dimensional imaging device comprises at least one electro-optical range imaging device in a form of a stereo camera, a light detection and ranging device, a time-of-flight camera or a combination.

8. An agricultural vehicle comprising at least one operating system an automatic guidance system of an agricultural vehicle, the at least one operating system, comprising:
at least one three-dimensional imaging device for capturing a real object and for deriving a three-dimensional data set for the real object; and
a touch-sensitive display unit for displaying an object and for receiving a touch input,
wherein the operating system is configured to generate three-dimensional data set based command signals corresponding to the interaction with the displayed object for operating the automatic guidance system.

9. A method of interactively operating using an operating system for operating an automatic guidance system of an agricultural vehicle formed with at least one three-dimensional imaging device for capturing a real object and for deriving a three-dimensional data set for the real object, a touch-sensitive display unit for displaying an object and for receiving a touch input, the system configured to generate three-dimensional data set based command signals corresponding to the interaction with the displayed object for operating the automatic guidance system, the method comprising the steps of:
deriving the three-dimensional data set for the real object captured by the three-dimensional imaging device;
displaying the object on the touch-sensitive display unit;
receiving feedback from the display unit from touch input interaction with the displayed object;
generating the three-dimensional data set based command signals corresponding to the interaction with the displayed object for operating the automatic guidance system.

10. The method according to claim 9, further comprising the step of generating the command signals in a form of control signals for directly controlling the agricultural vehicle.

11. The method according to claim 9, further comprising the step of recognising a captured real object.

12. The method according to claim 9, further comprising the step of storing, retrieving reference data or both in order to compare the derived three-dimensional data set with the reference data.

13. The method according to claim 9, further comprising the step of allocating data, changing data or both corresponding to the displayed object.

14. The method according to claim 9, further comprising the step of generating a visual feedback, an audible feedback or both in response to a touch input.

15. The method according to claim 9, further comprising the step of generating at least one virtual element corresponding to the displayed object.

16. The method according to claim 9, further comprising the step of selecting the displayed object for tracking the corresponding real object.

17. The method according to claim 9, further comprising the step of transferring the three-dimensional data sets to a further system.
